(19) United States
(12) Patent Application Publication
(10) Pub. No.: US 2020/0232438 A1
(43) Pub. Date: Jul. 23, 2020

(54) DEVICE FOR PRODUCING HYDRO-ELECTRIC POWER

(71) Applicant: Gilles GRANDPERRET, Vagney (FR)

(72) Inventor: Gilles GRANDPERRET, Vagney (FR)

(21) Appl. No.: 16/494,754

(22) PCT Filed: Mar. 14, 2018
(86) PCT No.: PCT/FR18/50604

§ 371 Date: Feb. 9, 2020

(30) Foreign Application Priority Data
Mar. 17, 2017 (FR) 1752188

(51) Int. Cl. F03B 11/00; F03B 7/00; F03B 13/10

(52) U.S. Cl. CPC F03B 11/002; F03B 13/10; F03B 7/00

(57) ABSTRACT

The device for producing hydro-electric power includes at least one water wheel rigidly connected to at least one platform, at least one upper face of which is above water. The water wheel is formed by a plurality of blades extending the free ends of arms distributed around a hub, and is intended to be set into rotation under the effect of the flow of the water from a water course about an axis with a horizontal aspect, perpendicular to the direction of flow of said water course, in order to activate a turbine and to produce electricity through a generator. The device includes an activator for a liquid compressor for a fluid intended to supply the turbine under the effect of the rotation of the water wheel.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a device for producing hydroelectric power including at least one water wheel connected to at least one platform, at least one upper face of which is above water, said water wheel being formed by a plurality of blades extending the free ends of arms distributed around a hub, and being intended to be set into rotation under the effect of the flow of a water course about an axis (X) with a horizontal aspect, perpendicular to the direction of flow of said water course, in order to activate a turbine and to produce electricity through a generator.

### 2. Description of Related Art Including Information Disclosed Under 37 CFR 1.97 and 37 CFR 1.98

Since the appearance of electricity in the second half of the 19th century, many technologies have progressively been developed in order to allow its spread throughout the world, to have power necessary for the concomitant industrial boom, and to meet the electricity needs generated by technological development.

In this context, many methods and devices for producing electricity from hydraulic power have thus appeared, currently making it possible to contribute to about 20% of the world's total electricity production.

In a known manner, the different types of infrastructure dedicated to transforming hydraulic power into electrical power known to date are specifically studied and dimensioned based on their implementation environment and the needs of the grid to which they are connected.

These infrastructures are sometimes based on a complex architecture requiring substantial financial means for their installation and implementation. Hydroelectric dams in particular generally involve a deep transformation of the site, following major civil engineering work that is extremely expensive and often subject to controversy, in particular due to its negative impact on the landscape, and repercussions for the surrounding ecosystem.

Less complex systems than dams also exist, the installation of which on a water course is less restrictive, for example those based on the implementation of water wheels. Known in particular from publication U.S. Pat. No. 4,598,210 is a device for producing hydroelectric power including two water wheels formed by a plurality of blades connected to an axis secured either to an electrical generator, or to an air compressor, or to a water pump or the like with which a platform is equipped that is intended to be anchored in a water course.

However, it has been observed that these devices often have low yields while nevertheless requiring a substantial investment. They are therefore not highly supported.

As a result, at this time, although hydroelectricity is considered a renewable power that respects the environment, its production still raises many issues that limit its development, despite the tremendous potential otherwise hoped for.

### BRIEF SUMMARY OF THE INVENTION

The present invention therefore aims to propose an innovative device for producing hydroelectric power, with a simple structure, the installation of which requires little or no civil engineering work and which has a low impact on the surrounding landscape, such a device allowing electrical power production through a method that respects the environment, produces few greenhouse gases, has no impact on the flora and fauna of the site, and on the contrary contributes to preservation of the water course, while having a high efficiency.

To that end, the present invention relates to a hydroelectric power-producing device of the type indicated in the preamble, characterized in that it includes means for activating, under the effect of the rotation of the water wheel, at least one means for compressing a fluid intended to supply said turbine.

According to one feature of the invention, said means for compressing a fluid include at least one air compressor having an enclosure provided with at least one air inlet orifice, and at least one compressed air outlet orifice communicating with said turbine, said chamber being delimited by a bottom, an upper flap, and a peripheral wall whereof at least a portion is deformable, said bottom or said upper flap being movable between an inactive state in which said bottom and said flap together form an acute angle α0 and an active state in which they together form an acute angle α1 of less than α0, while said activating means include at least one rotary bar, with axis parallel to the plane formed by said water wheel, said rotary bar being rotated about said axis (X) by said water wheel through a shaft coupled to said hub, and including at least one free end secured to a member designed to be capable of acting on the upper flap or the bottom of said enclosure to cause it to move from its inactive state to its active state.

According to one conceivable embodiment variant, said member is defined by a caster mounted rotating on the free end of the rotary bar, about an axis parallel to the axis X, said caster being designed able to exert, on the upper flap, an action having a component with a vertical aspect oriented toward the water course, during the rotation of the rotary bar.

According to another conceivable embodiment variant, said member is defined by a connecting rod whereof a first end is secured to the free end of the rotary bar and a second end is mounted rotating about an axis parallel to the axis X on an arm extending in the extension of the upper flap or of the bottom of said enclosure, parallel to the plane formed by the latter.

According to one additional feature of the invention, said enclosure contains at least one resilient return means extending between said bottom and said upper flap, and against which the movement of said upper flap toward its active state takes place.

The present invention also provides that said upper flap is mounted rotating relative to said bottom and is connected to rotational guide means.

Another feature is defined by the fact that the peripheral wall is folded in an accordion while forming horizontal folds and is movable between a stretched position and a gathered position.

Furthermore, the peripheral wall can advantageously be at least partially made from a deformable material such as “flexible” Vitrimer (registered trademark), while the upper flap and/or the bottom is/are made from a rigid material such as “hard” Vitrimer (registered trademark).

The device according to the invention also has the specificity of including, at least in one specific embodiment variant, a compressed air reservoir connected to the compressed air outlet orifice of said enclosure by a first channel and a compressed air inlet orifice of said turbine by a second channel.

In this case, the opening and closing of said first and second channels are preferably controlled by first and second solenoid valves.

Furthermore, the invention can also provide that said enclosure includes a compressed air outlet orifice connected with a channel configured to emerge in said water course and, if applicable, to circulate on the path followed by the compressed air after it is injected into said turbine through its compressed air inlet orifice.

According to one conceivable embodiment variant, the means for compressing a fluid can also include at least a hydraulic jack or a hydrostatic motor extending in said enclosure between said bottom and said upper flap.

The hydraulic jack is then connected to said turbine using channels on the path of which at least one compressed oil reservoir is placed.

Furthermore, the device according to the invention is also characterized in that said platform is provided with floats making it possible to keep at least its upper face above water.

### BRIEF DESCRIPTION OF THE SEVERAL VIEWS OF THE DRAWINGS

Other features and advantages of the invention will emerge from the following detailed description relative to two exemplary embodiments of the device for the production of hydroelectric power, provided solely for information and non-limitingly.

The understanding of this description will be facilitated in reference to the attached drawings.

FIG. 1 illustrates a schematic side view of a first embodiment variant of a device for producing hydroelectric power according to the invention.

FIG. 2 is a schematic top view of the device of FIG. 1.

FIGS. 3 to 6 correspond to schematic side views of the device of FIG. 1 during different operating phases.

FIG. 7 corresponds to a schematic side view of a second embodiment variant of a device for producing hydroelectric power according to the invention.

FIG. 8 illustrates an enlarged schematic view of the air compressor of the device of FIGS. 1 to 7.

FIGS. 9 and 10 illustrate a detailed schematic view according to two different states of a structural element of the device of FIG. 1.

FIGS. 11 to 15 correspond to schematic side views of another embodiment variant of the device according to the invention during an operating cycle.

### DETAILED DESCRIPTION OF THE INVENTION

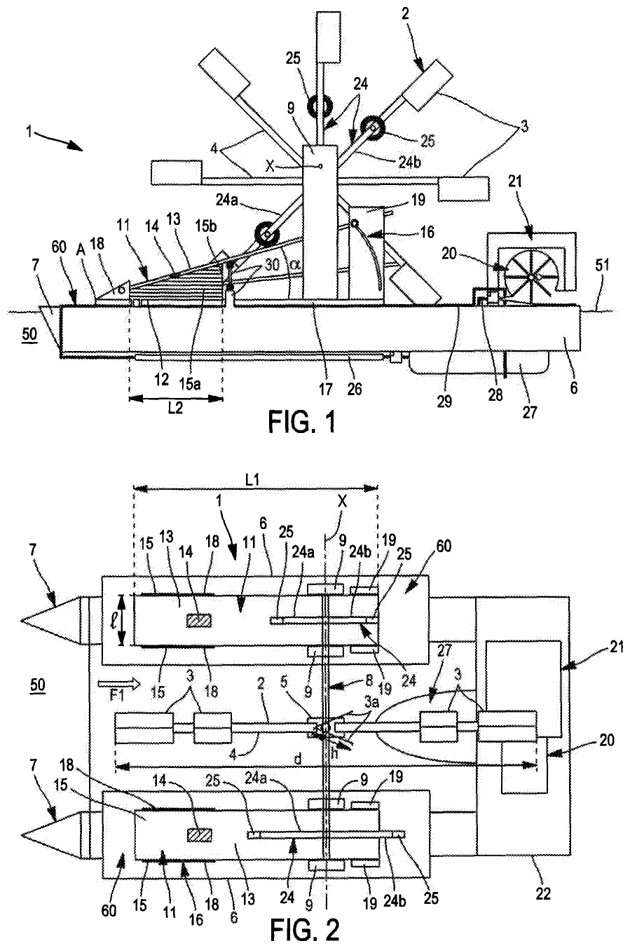

In the embodiment variants illustrated in FIGS. 1 to 10, the hydroelectric power-producing device 1, 10 according to the invention includes a water wheel 2 having a plurality of blades 3 with a V-shaped section extending arms 4 uniformly distributed around a hub 5. Conventionally, its rotation in the direction of the arrow F, allowing the production of mechanical power, is done about an axis X that is both horizontal and perpendicular to the direction of flow F1 of the water course 50 in which the water wheel 2 is installed, and is caused by forces coming from the transfer of masses between the water and the blades 3.

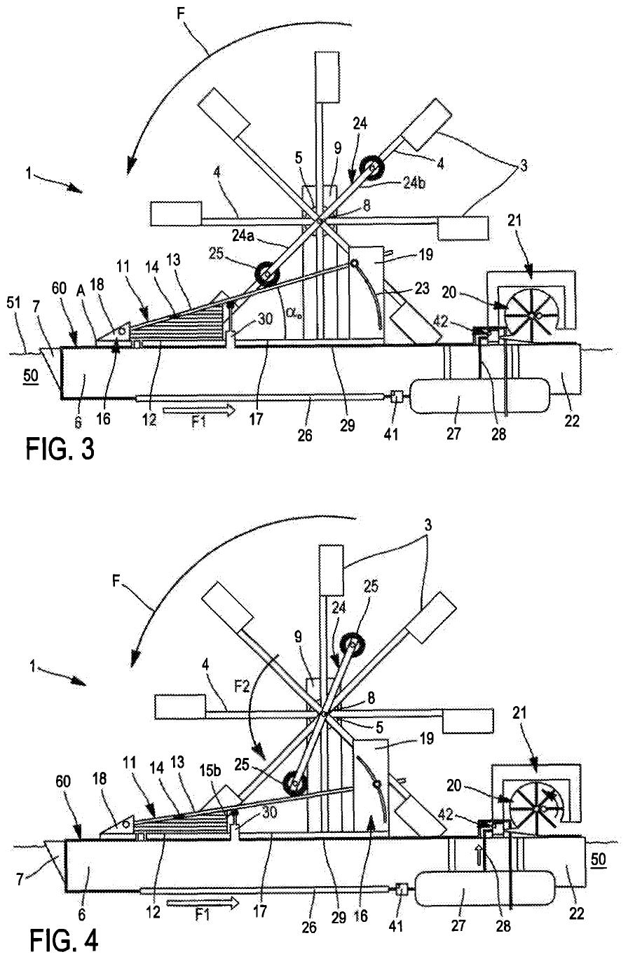

The produced mechanical power makes it possible to drive a turbine 20 connected to an electrical power generator 21. It should be noted that in the illustrated examples, the water wheel 2 has a diameter d of about 5 m, and is provided with blades 3 whereof each flap 3a has a height h (cf. FIG. 2) on the order of 0.6 m. Such a water wheel 2 is more particularly designed and dimensioned for installation of the device 1, 10 in a stream or river 50 having a flow rate of at least 1 m/s, and having a minimum depth of 2.5 m. Of course, it is, however, possible to adapt the device to the specificities of the considered site by in particular providing dimensions other than those indicated above for the blades 3 and the water wheel 2.

The latter is also secured to a floating platform including two elements 6, at least the upper face 60 of which is above the level 51 of the water course 50. The two elements 6 are each provided with a float 7 and are moored, for example to a bank, by appropriate means, in particular a metal cable (not illustrated), or any other equivalent means.

In reference to FIG. 2, in the illustrated examples, the water wheel 2 is in fact supported, through a shaft 8 with axis X passing through the hub 5, by two pairs of pillars 9 erected on the upper face 60 of the platform elements 6, and each extending on either side of the plane formed by the water wheel 2. The turbine 20 and the generator 21 are supported by a pedestal 22 extending transversely, downstream from the elements 6.

According to the invention, in the embodiment variants illustrated in FIGS. 1 to 10, the device 1, 10 also includes two air compressors 11 each supported by a platform element 6. They are arranged between a pair of pillars 9 and connected to the turbine 20.

Each air compressor 11 includes an enclosure, overhanging the upper face 60 of an element 6. Each enclosure is delimited by a bottom 12, an upper flap 13 provided with a valve 14 for the surrounding air inlet and a peripheral wall 15.

Preferably, the upper flap 13 and/or the bottom 12 are/is made from a rigid material, in particular “hard” Vitrimer (registered trademark), a plastic, a metal, a composite material or any other equivalent material.

The peripheral wall 15 is deformable and to that end is accordion-folded, such that each of the folds that it includes extends in a horizontal plane. It is preferably made from a flexible material, such as “flexible” Vitrimer (registered trademark), or any other equivalent material.

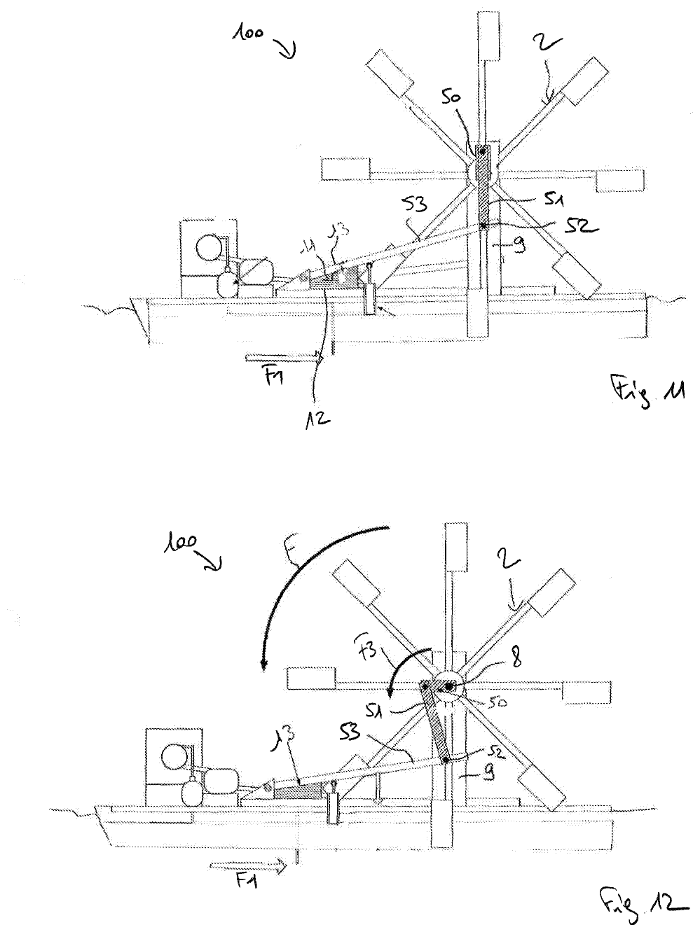

The enclosure is also secured to a frame 16, for example made from aluminum, having a parallelepiped base 17 and including, on either side of its upstream, downstream ends, a pair of platens 18, 19 extending vertically and to which the upstream 13a and downstream 13b edges of the upper flap 13 of said enclosure (cf. FIG. 8) are connected.

Indeed, the upper flap 13 forms, with the horizontal bottom 12 of the enclosure, an acute angle a whereof the apex A (cf. FIG. 1 and FIG. 8) is oriented so as to be situated on the side of the upstream edge 13a of the upper flap 13.

The latter is also mounted rotatably on the platens 18 about an axis parallel to the axis X, while the downstream edge 13b is guided in rotation relative to the platens 19, which to that end each include a guiding slide 23.

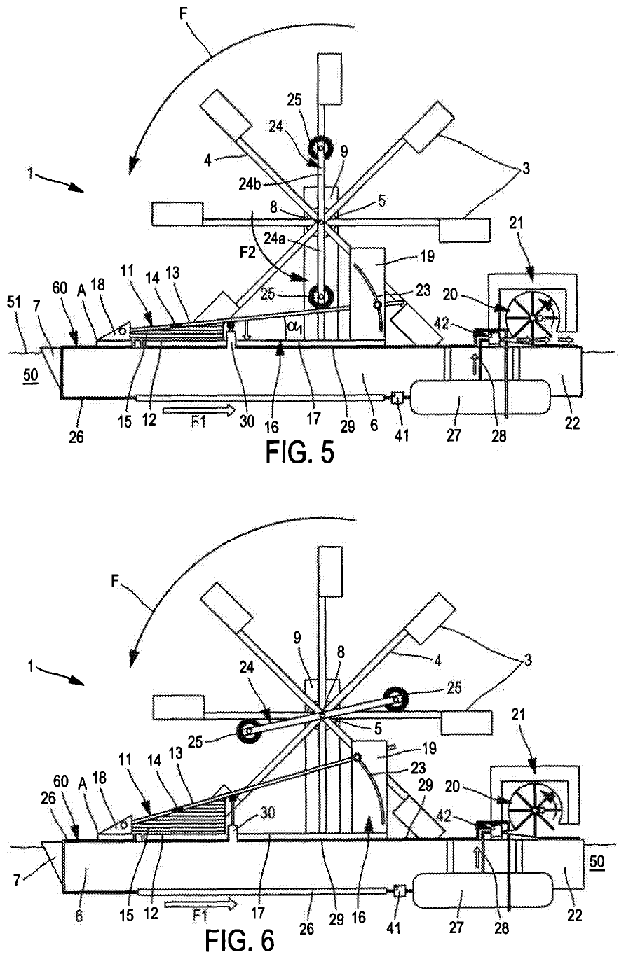

The upper flap 13 of each air compressor 11 is thus movable between an inactive position in which it forms an angle α0 with the bottom 12 (FIG. 3) and the peripheral wall 15 is unfolded, and an active position in which it forms, with the bottom 12, an angle α1 smaller than α0 (FIG. 5) and the peripheral wall 15 is gathered.

It should also be specified that the upper flap 13 of each air compressor 11 has a length L1 chosen from among the range of values from 2.5 m to 6 m for a width I chosen from among the range of values of from 1 m to 2 m, while the peripheral wall 15 has two opposite lateral walls 15a whereof the length L2 is between 1 m in 2 m and a rear wall 15b with width I between 1 m and 2 m (cf. FIGS. 1 and 2).

In the embodiment variant illustrated in FIGS. 1 to 6, the enclosure of each air compressor 11 communicates with the first channel 26 connected to a compressed air reservoir 27, shared by the two compressors 11 for example located below the water, and in turn connected to the turbine 20 through a second channel 28. Two solenoid valves 41, 42, arranged upstream respectively from the reservoir 27 and the turbine 20, make it possible to control the opening and closing of the channels 26, 28. The enclosure also includes an additional channel 29, configured to emerge in said water course 50 and to pass, in the turbine 20, through the journey made by the compressed air coming from the reservoir 27.

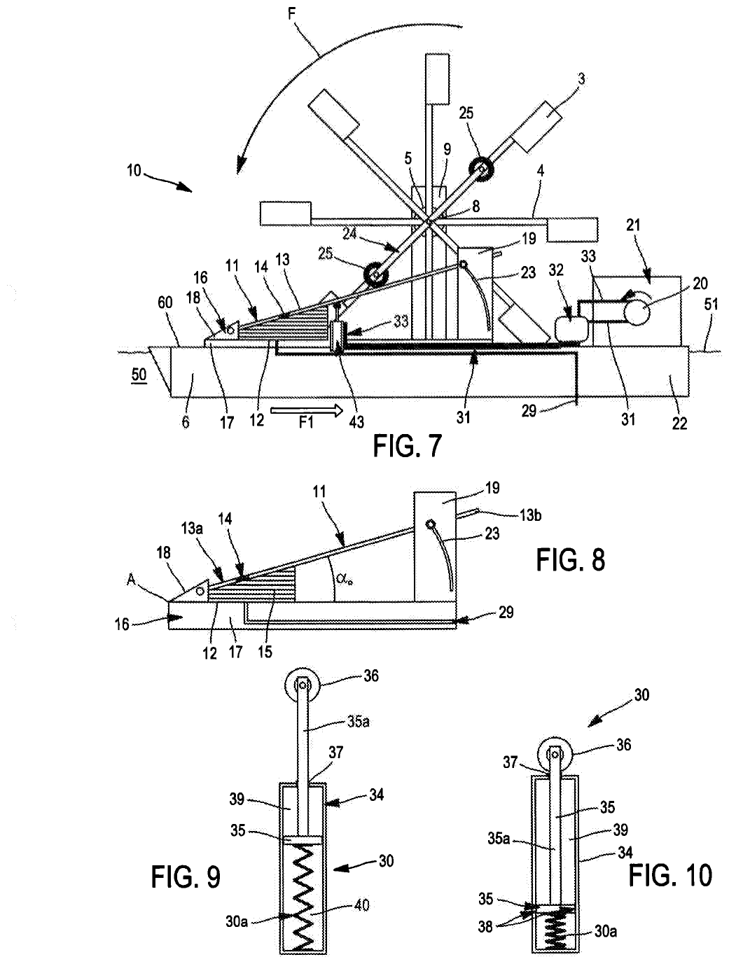

It should be noted that in the embodiment variant illustrated in FIG. 7, the device 10 does not include a compressed air reservoir 27, while the enclosure of each air compressor 11 is only connected to the single channel 29 communicating with the water course 50.

According to the invention, in both illustrated embodiment variants, the change of position of the upper flap 13 of each air compressor 11 of the device 1, 10, from its inactive state toward its active state, is done using a rotary bar 24 subject to the movement of the shaft 8, in turn rotated in the direction of the arrow F by the rotation of the water wheel 2. Each rotary bar 24 is thus coupled to the shaft 8, and engaged thereupon so as to extend perpendicular to the water wheel 2, between two pillars 9, above an upper flap 13 and such that it has two segments 24a, 24b, preferably identical in length, extending around the shaft 8. Furthermore, the length of each rotary bar 24 is chosen such that during its rotation, each of the casters 25, with which the end of each of the segments 24a, 24b is equipped, successively comes into contact with the upper flap 13 of an air compressor 11.

In other words, the passage to the active position of each upper flap 13 is done by progressive bearing, on the latter, of a caster 25 during the travel that it performs above it, during the rotation in the direction of the arrow F2, of the rotary bar 24.

Regarding the embodiment variant illustrated in FIGS. 1 to 6, this phase is accompanied by a compression of at least one resilient return means 30 extending between the bottom 12 of said enclosure and the upper flap 13 (cf. FIG. 3-5). When the caster 25, during the rotation in the direction of arrow F2 of the rotary bar 24, leaves the upper flap 13 (cf. FIG. 6), the latter is released from the pressure exerted by the rotary bar 24 via a caster 25 and in turn releases the resilient return means 30, the relaxation of which then allows the complete return toward its inactive position of said upper flap 13.

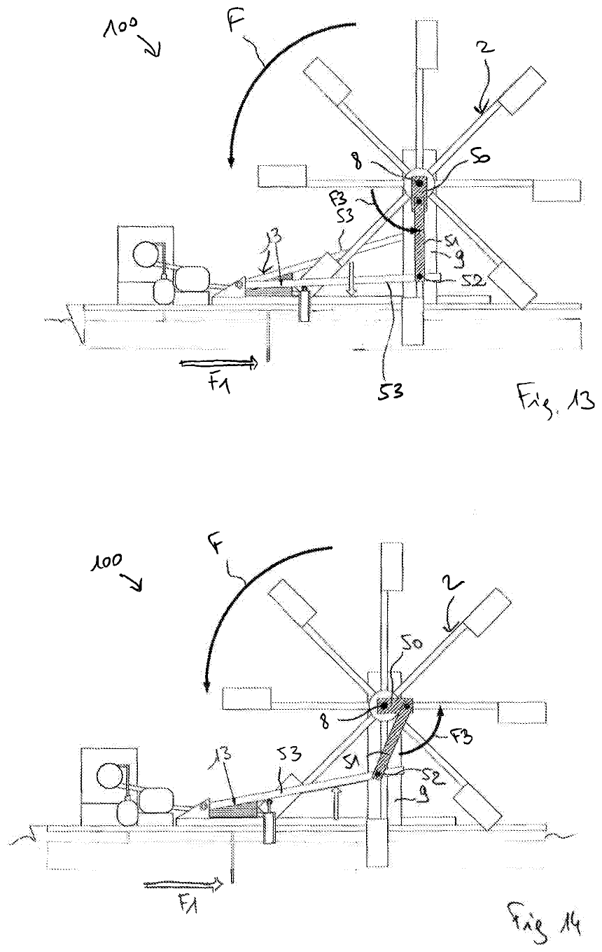

More specifically in reference to FIGS. 9 and 10, in the illustrated embodiment variant, the resilient return means 30 includes a compression spring 30a, housed at the bottom of a vertical cylinder 34 extending from the bottom 12 of the enclosure of an air compressor 11. The compression spring 30a is connected at its upper end to a piston 35 whereof the arm 35a emerges from the cylinder 34 and is provided with a caster 36, bearing against the inner face of the upper flap 13. The cylinder 34 is provided with a first joint 37 positioned in the vicinity of its upper edge and a second joint 38 placed around the piston 35 on the upper end of the compression spring 30a. Thus, the cylinder 34 is split into an upper chamber 39 in which the arm 35a of the piston 35 is housed and a lower chamber 40, in which the compression spring 30a is housed, and the volume of which varies as a function of the vertical translational movement of the piston 35 caused by the movement of the upper flap 13. When the volume of the lower chamber 40 decreases, the air that is contained therein is compressed, like the compression spring 30a that is housed therein. It is ultimately the relaxation of both the compression spring 30a and the air contained in the lower chamber 40 that will allow the complete return of the upper flap 13 into its inactive position and the unfolding of the peripheral wall 15.

In reference to FIGS. 1 to 6, owing to such a structure of the device 1 according to the invention, in the inactive position of the upper flap 13, in which the peripheral wall 15 is stretched (FIG. 3), and the solenoid valves 41, 42 are closed, the surrounding air penetrating the enclosure is at atmospheric pressure. When the upper flap 13 gradually moves toward its active position under the action of the rotary bar 24 driven by its rotational movement, the peripheral wall 15 is gathered (FIG. 5), the volume of the enclosure decreases, causing the compression of the air contained therein. After the opening of the solenoid valves 41, 42, the compressed air is discharged through an air outlet orifice toward the first channel 26 connected to the compressed air reservoir 27, where it may be temporarily stored before being injected into the turbine 20 through the second channel 28, to allow electricity production by the generator 21. Another part of the compressed air produced in the air compressor 11 is discharged from the enclosure using the additional channel 29 configured to emerge into said water course and passing, in the turbine 20, through the path followed by the compressed air coming from the reservoir 27. This last characteristic makes it possible on the one hand to inject air into the water course and therefore to participate in its oxygenation, and on the other hand to heat the compressed air coming from the reservoir 27 to prevent any ice formation phenomena at the inlet of the turbine 20 that would be detrimental to the performance of the device 1.

As already indicated above, in the embodiment variant illustrated in FIG. 7, the device 10 according to the invention only includes a single channel 29 for discharging the compressed air produced by each air compressor 11 directly into the water course, and has no compressed air reservoir. Indeed, in this variant, the turbine is driven by the compressed oil produced using at least one hydraulic jack 43 extending between the bottom 12 of each air compressor 11 and its upper flap 13 and actuated during the movement of the latter between its inactive position and its active position under the effect of the rotary bar 24. Indeed, in this variant, the compressed oil produced in the jack 43 is discharged using a channel 31 toward the turbine 20 via a reservoir 32 for at least temporary oil storage. At the outlet of the turbine 20, the oil, again at atmospheric pressure, re-supplies the hydraulic jack 29 via a channel 33.

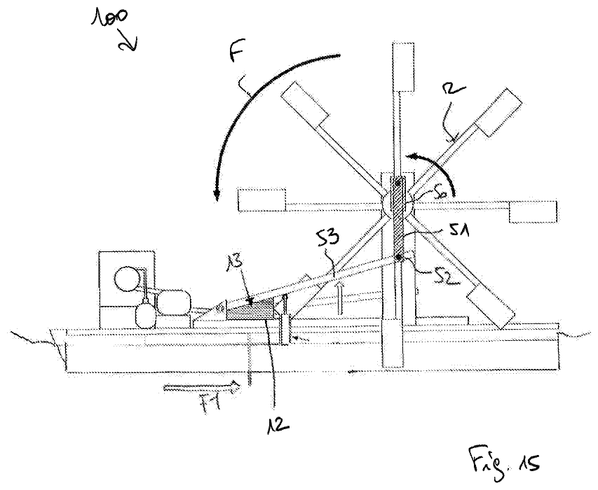

The present application also intends to cover other embodiment variants of the device according to the invention, in particular the one whereof the operation is illustrated in FIGS. 11 to 15. Because its structure is nearly identical to that of the embodiment variant shown in FIG. 7, only a few shared structural elements as well as the elements differing from the latter have been referenced in the drawings, for clarity reasons.

Thus, as illustrated in FIGS. 11 to 15, the invention also relates to a device for producing hydroelectric power 100, with which the position change of the upper flap 13 of each air compressor 11 from its inactive state to its active state is done using an assembly formed on the one hand by a rotary bar 50 subject to the movement of the shaft 8, in turn rotated in the direction of the arrow F by the rotation of the water wheel 2, and on the other hand the connecting rod 51, in turn subject to the rotational movement of the rotary bar 50. Indeed, each rotary bar 50 is coupled, by one of its ends to the shaft 8, and engaged thereupon so as to extend perpendicular to the water wheel 2, between two pillars 9, above an upper flap 13. The connecting rod 51 is connected securely, by one of its ends, to the rotary bar 50, while its other end is mounted rotating, about an axis 52 parallel to the rotation axis of the water wheel 2, on an arm 53 extending in the extension of the upper flap 13 or the bottom 12 of said enclosure, parallel to the plane formed by the latter.

Owing to such a structure, the passage from the inactive position of the upper flap 13 (FIG. 11) to its active position (FIG. 12-13) is done by progressive bearing of the connecting rod 51 on the arm 53 during the journey that it performs, over the course of the rotation in the counterclockwise direction (illustrated by the arrow F3) of the rotary bar 50. Thus, at the beginning of the rotational movement of the arm 50, the connecting rod 51 subjects the arm 53 to an action with a vertical component oriented in the direction of the water course. Then, by continuing its journey, the connecting rod 51 subjects the arm 53 to an action with a vertical component oriented in the direction of the shaft 8 of the water wheel 2, thus causing the upper flap 13 to return to its inactive position (FIG. 14-15).

As clearly emerges from the preceding, the present invention makes it possible to achieve the aims set out in the preamble through a device 1, 10 for producing hydroelectric power implementing a water wheel with improved efficiency owing to the lever effect of the two rotary bars 24 making it possible to multiply the mechanical power transmitted to the turbine 20 through air compressors 11 and/or the hydraulic jack 43. It is thus conceivable to reach a power from about 50 kW/h to 250 kW/h with a current speed of 1 m/s.

Furthermore, owing to its simplified structure, the device 1, 10 according to the invention makes it possible to generate a renewable electric current with an improved efficiency without requiring substantial civil engineering work, therefore through a low investment and reduced environmental impact, and thus impact on the landscape. Furthermore, owing to significant mixing of the water accompanied by a regular injection of air into the water, the device 1, 10 according to the invention contributes to improving the quality of the water course in which it is installed and has positive effects on the entire surrounding ecosystem.

1. A device for producing hydroelectric power, comprising:
at least one water wheel connected to at least one platform, at least one upper face of which is above water, said water wheel being comprised of a plurality of blades extending the free ends of arms distributed around a hub, and being intended to be set into rotation under the effect of the flow of a water course about an axis with a horizontal aspect, perpendicular to the direction of flow of said water course, in order to activate a turbine and to produce electricity through a generator; and
means for activating, under the effect of the rotation of the water wheel, at least one means for compressing a fluid intended to supply said turbine.

2. The device according to claim 1, wherein said means for compressing a fluid comprises at least one air compressor having an enclosure provided with at least one air inlet orifice, and at least one compressed air outlet orifice communicating with said turbine, said chamber being delimited by a bottom, an upper flap, and a peripheral wall whereof at least a portion is deformable, said bottom or said upper flap being movable between an inactive state in which said bottom and said upper flap together form an acute angle α0 and an active state in which they together form an acute angle α1 of less than α0, while said activating means include at least one rotary bar, with axis parallel to the plane formed by said water wheel, said rotary bar being rotated about said axis by said water wheel through a shaft coupled to said hub, and including at least one free end secured to a member designed to be capable of acting on the upper flap or the bottom of said enclosure to cause it to move from its inactive state to its active state.

3. The device according to claim 2, wherein said member is comprised of a caster mounted rotating on the free end of the rotary bar, about an axis parallel to the axis X, said caster being designed able to exert, on the upper flap, an action having a component with a vertical aspect oriented toward the water course, during the rotation of the rotary bar.

4. The device according to claim 2, wherein said member is comprised of a connecting rod, wherein a first end is secured to the free end of the rotary bar and a second end is mounted rotating about an axis parallel to the axis on an arm extending in the extension of the upper flap or of the bottom of said enclosure, parallel to the plane formed by the latter.

5. The device according to claim 2, wherein said enclosure contains at least one resilient return means extending between said bottom and said upper flap, and against which the movement of said upper flap toward its active state takes place.

6. The device according to claim 2, wherein said upper flap is mounted rotating relative to said bottom and is connected to rotational guide means.

7. The device according to claim 2, wherein the peripheral wall is folded in an accordion while forming horizontal folds and is movable between a stretched position and a gathered position.

8. The device according to claim 7, wherein the peripheral wall is at least partially made from a deformable material, while the upper flap and/or the bottom is/are made from a rigid material.

9. The device according to claim 2, further comprising: a compressed air reservoir connected to the compressed air outlet orifice of said enclosure by a first channel and a compressed air inlet orifice of said turbine by a second channel.

10. The device according to claim 9, wherein the opening and closing of said first and second channels are controlled by first and second solenoid valves.

11. The device according to claim 2, wherein said enclosure comprises a compressed air outlet orifice connected with said turbine via a channel configured to emerge into said water course.

12. The device according to claim 11, wherein the channel is configured to circulate on the path followed by the compressed air after it is injected into said turbine through its compressed air inlet orifice.

13. The device according to claim 2, wherein said means for compressing a fluid comprises at least a hydraulic jack or a hydrostatic motor extending in said enclosure between said bottom and said upper flap.

14. The device according to claim 13, wherein said hydraulic jack or a hydrostatic motor is connected to said turbine using channels between which at least one compressed oil reservoir is placed.

15. The device according to claim 1, wherein said platform is provided with floats.
